(19) United States
(12) Patent Application Publication
(10) Pub. No.: US 2013/0298841 A1
(43) Pub. Date: Nov. 14, 2013

(54) Structure for Aquatic Farming

(71) Applicants: Nelson Vadassery, Chennai (IN); Sayash Kumar, Chennai (IN); Sowmya Lakshmi Balendiran, Chennai (IN); Sri Sailaja Nori, Chennai (IN); Shrikumar Suryanarayan, Bangalore (IN)

(72) Inventors: Nelson Vadassery, Chennai (IN); Sayash Kumar, Chennai (IN); Sowmya Lakshmi Balendiran, Chennai (IN); Sri Sailaja Nori, Chennai (IN); Shrikumar Suryanarayan, Bangalore (IN)

(21) Appl. No.: 13/980,531

(22) PCT Filed: Jan. 19, 2012
(86) PCT No.: PCT/IN12/00047

§ 371 Date: Jul. 18, 2013

(51) Int. Cl. A01K 61/00; F16B 7/00

(52) U.S. Cl. CPC A01K 61/007; A01K 61/00; F16B 7/00
USPC 119/223; 119/215; 403/220

(57) ABSTRACT

The present subject matter relates to a farming structure (1) for aquatic farming. The farming structure (1) comprises a plurality of longitudinal members (3) and a plurality of flexible joints (4), one at each end of each of the plurality of longitudinal members (3), coupling the plurality of longitudinal members (3) to form repeating triangular structures (5) adjacent to each other. Each end of each of the plurality of longitudinal members (3) is independently movable in a horizontal plane and a vertical plane about a corresponding flexible joint (4).

### FIELD OF INVENTION

The present subject matter in general relates to a structure and, particularly but not exclusively, to a farming structure for aquatic farming.

### BACKGROUND

Aquatic farming of multicellular organisms for production of bio-mass, such as seaweeds, is known for a long time. Aquatic farming includes floating-type and submerged-type farming which are typically done using a farming structure on which multicellular organisms are supported and grown. In floating-type farming, the farming structure either floats on the water surface of a water-body or floats partially below the water surface. On the other hand, in submerged-type farming the farming structure is held immersed in the water-body. The farming structures are typically supported by buoys that provide suitable buoyancy to the floating structures, either for the purpose of floating-type farming or for the purpose of submerged-type farming. In addition, the farming structures, for the purpose of aquatic farming, are typically anchored to the base of the water-body to hold its position in the water-body.

### SUMMARY

This summary is provided to introduce concepts related to a farming structure for aquatic farming. This summary is neither intended to identify essential features of the claimed subject matter nor is it intended for use in determining or limiting the scope of the claimed subject matter.

In accordance with an embodiment of the present subject matter, a farming structure for aquatic farming comprises a plurality of longitudinal members and a plurality of flexible joints, one at each end of each of the plurality of longitudinal members, coupling the plurality of longitudinal members to form repeating triangular structures adjacent to each other. Each end of each of the plurality of longitudinal members is independently movable in a horizontal plane and a vertical plane about a corresponding flexible joint.

### BRIEF DESCRIPTION OF DRAWINGS

The detailed description is described with reference to the accompanying figures. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a farming structure for aquatic farming of multicellular organisms, according to an embodiment of the present subject matter.

FIG. 2a illustrates a flexible joint of the farming structure, according to an embodiment of the present subject matter.

FIG. 2b illustrates a flexible joint coupling three longitudinal members of the farming structure, according to an embodiment of the present subject matter.

FIG. 3a illustrates a flexible joint of the farming structure, according to another embodiment of the present subject matter.

FIG. 3b illustrates a flexible joint coupling six longitudinal members of the farming structure, according to an embodiment of the present subject matter.

FIG. 4 illustrates the farming structure with external flotation means, according to an embodiment of the present subject matter.

FIG. 5 illustrates the farming structure anchored at a surface of a water-body, according to an embodiment of the present subject matter.

FIG. 6 illustrates a triangular structure of the farming structure with supporting means for cultivation of multicellular organisms, according to an embodiment of the present subject matter.

It should be appreciated by those skilled in the art that any block diagrams herein represent conceptual views of illustrative systems embodying the principles of the present subject matter.

### DETAILED DESCRIPTION

The present subject matter relates to farming structures for aquatic farming of multicellular organisms.

Farming structures utilized for aquatic farming typically experience stress of water waves while floating on or submerged in a water-body. Water waves usually impart irregular multidirectional stress on the farming structures. Farming structures that are conventionally utilized in aquatic farming are not substantially flexible to absorb the irregular stress of water waves. Due to the substantially low flexibility, the conventional farming structures are unable to sustain their configuration and order, and tend to collapse in water and damage under the stress of water waves. This makes the conventional farming structures for aquatic farming less durable.

The state of the art, for example disclosed in patent documents U.S. Pat. No. 7,587,991 and U.S. Pat. No. 5,309,672, relates to farming structures having a level of flexibility and/or durability. However, the conventional farming structures involve complicated assemblies which are difficult to assemble and require substantially large amount of material. Such conventional floating structures involve substantially high costs and their assembly is substantially complex and laborious. In addition, such conventional farming structures are not designed to adapt its shape to that of the water waves in the water-body and are not modularly expandable.

Thus, there is a need of a farming structure for aquatic farming, which is substantially flexible, capable of adapting its shape to that of the water waves, sustaining its configuration and intrinsic shape without collapsing under the stress of water waves, easy to assemble, modular and involves low costs.

The present subject matter describes farming structures for aquatic farming of multicellular organisms. The farming structures of the present subject matter are substantially flexible such that their configuration and the intrinsic shape are maintained under the influence of water waves while the farming structure is floating on or submerged in a water-body for the purposes of aquatic farming. In addition, the farming structure of the present subject matter is modular, scalable and easy to assemble, and is of low cost.

The farming structure of the present subject matter is formed by inter-connecting a plurality of longitudinal members through a plurality of flexible joints. The longitudinal members are inter-connected to form repeating triangular structures adjacent to each other. Each flexible joint forms a vertex of at least one of the triangular structures and couples two or more longitudinal members. The farming structure can be easily extended modularly to any desirable extent in the plane of the farming structure. Configuration of the farming structure of the present subject matter draws analogy from a lattice structure whose basis is a triangle.

In the farming structure of the present subject matter, the flexible joints are configured in a manner that offers flexibility to the each longitudinal member in one or more or all directions. With one flexible joint at each vertex, each triangular structure maintains its intrinsic shape under the stress of water waves. In an implementation, the flexible joints may include pivot joints, hinge joints, ball-socket joints or other similar joints or a combination thereof. The flexible joints can be attached to the longitudinal members by bolting, welding, cementing with appropriate adhesive compounds or any other attaching ways conventionally known to a skillful person.

The farming structure of the present subject matter may be utilized for floating-type aquatic farming or submerged-type aquatic farming. In the floating-type aquatic farming, the farming structure either floats on or partially below the surface of water in a water-body, and in the submerged-type aquatic farming, the farming structure is submerged or immersed in water in a water-body but floats at a certain distance or level below the water surface. In an implementation, for the purpose of flotation of the farming structure below the water surface, the farming structure may be coupled to a flotation means, such as buoys. In one implementation, for the purpose of flotation of the farming structure either on or partially below the water surface, the longitudinal members of the farming structure may be floatable.

With the repeating triangular structures and flexible joints, the farming structure of the present subject matter is substantially flexible and capable of adapting itself to the wave profiles that occur on the water surface or inside the water bodies. Thus, the farming structure of the present subject matter has a substantially less tendency to collapse or get damaged in the water-body under the influence of stress of the water waves.

These and other advantages of the present subject matter would be described in greater detail in conjunction with the following figures. It should be noted that the description and figures merely illustrate the principles of the present subject matter. Additionally, the word “connected” or “coupled” is used throughout for clarity of the description and can include either a direct connection or an indirect connection.

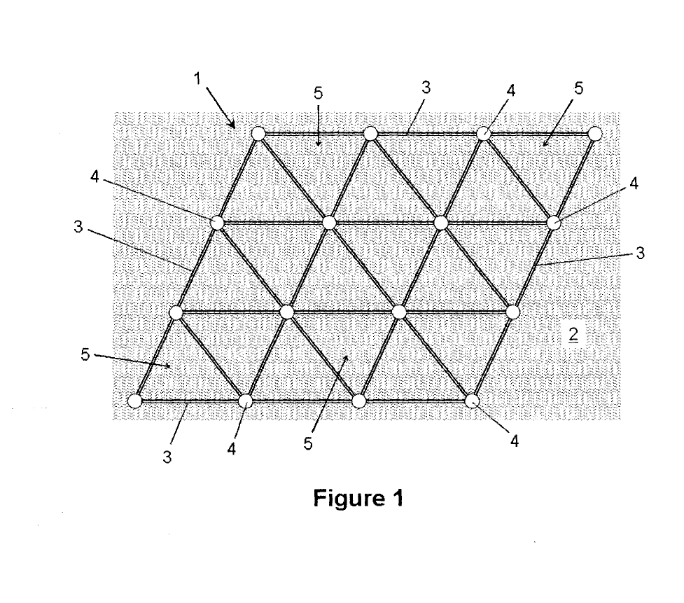

FIG. 1 illustrates a farming structure 1 for farming or cultivation of aquatic multicellular organisms, according to an embodiment of the present subject matter. The farming structure 1 may either be floating on or submerged below the surface of a water-body 2 depending on the type of farming being done. In an implementation, the aquatic multicellular organisms cultivated on the farming structure 1 of the present subject matter may be photosynthetic. In an implementation, the aquatic multicellular organisms include seaweed species.

The farming structure 1 of the present subject matter includes longitudinal members 3 coupled with each other through flexible joints 4. The longitudinal members 3 are coupled to form repeating triangular structures 5 that form the entire farming structure 1. It may be understood that the longitudinal members 3 form the sides of the triangular structures 5 and the flexible joints 4 are at the vertices of the triangular structures 5. In an implementation, each longitudinal member 3 forms the side of at least one triangular structure 5 and each flexible joint 4 is at one vertex of at least one triangular structure 5. Further, in an implementation, at each flexible joint 4 at least two longitudinal members 3 are coupled, as shown in FIG. 1. The farming structure 1 can be scaled in any direction, particularly along the surface of the water-body 2, by repeating the triangular structures 5 by coupling the longitudinal members 3 through the flexible joints 4.

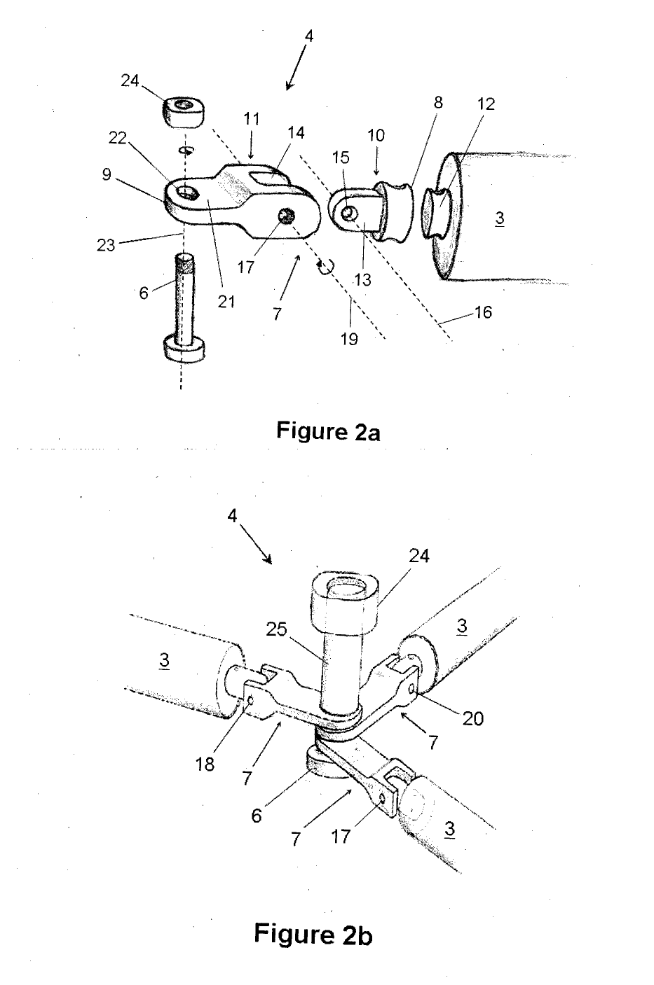

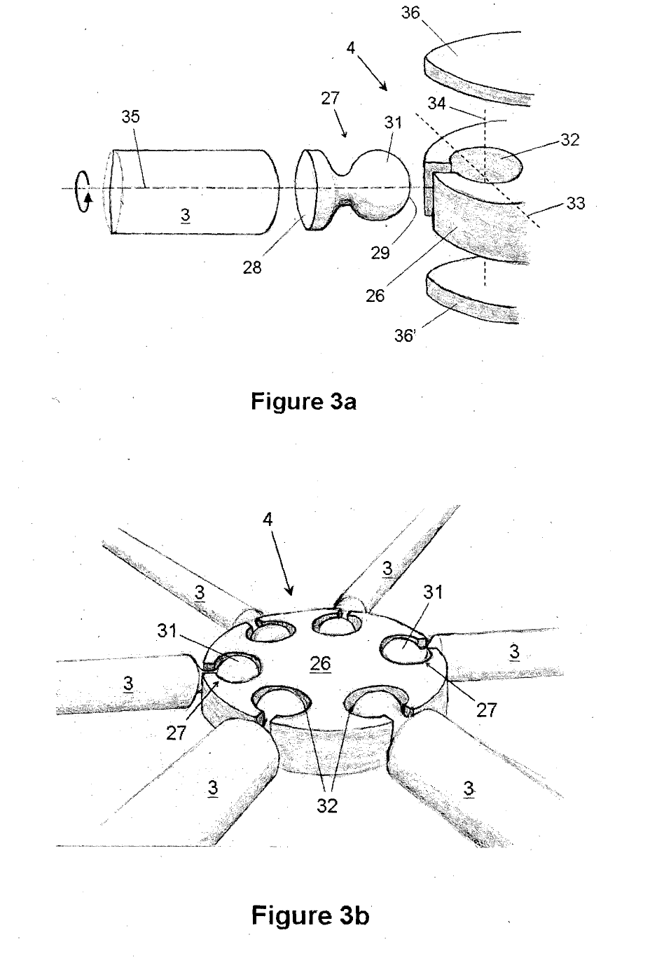

Each flexible joint 4 provides flexibility in one or more or all directions to the each of the longitudinal members 3 coupled thereat. In an implementation, the flexible joint 4 is configured to provide movements to the respective longitudinal member 3 in a vertical plane and a horizontal plane about itself. The flexible joints 4, the coupling of the longitudinal members 3 thereat and the movements of the longitudinal members 3 are explained in the descriptions of FIGS. 2a, 2b, 3a and 3b.

In an implementation, the longitudinal members 3 may be columns or bars with one dimension longer than the other two dimensions. In an implementation, the longitudinal members 3 may be rigid columns or bars with substantially equal lengths and having cross-sections of substantially circular or polygon shapes. Further, in an implementation, the longitudinal members 3 may be made of plastics, metals, composites or a combination thereof.

FIGS. 2a and 2b illustrate the flexible joint 4 of the farming structure 1, according to an embodiment of the present subject matter. FIG. 2a illustrates the flexible joint 4, in an unassembled or uncoupled state, for coupling an end of one longitudinal member 3, and FIG. 2b illustrates the flexible joint 4 coupling three longitudinal members 3. The flexible joint 4 includes a hub element 6 and a predefined number of connection elements 7 for coupling the longitudinal members 3. One longitudinal member 3 is coupled to the flexible joint 4 through one connection element 7. The number of connection elements 7 at the flexible joint 4 is dependent on the number of longitudinal members 3 to be coupled thereat. In an implementation, the number of connection elements 7 at one flexible joint 4 may be two to six.

The connection element 7, as shown in FIG. 2a, has a first end 8 configured to fixedly couple the end of the longitudinal member 3 and has a second end 9 configured to couple the same connection element 7 to the hub element 6. In an implementation, each connection element 7 is configured to allow the respective longitudinal member 3 to move in a vertical plane and a horizontal plane about the hub element 6. Further details of configuration of the connection element 7, its coupling with the longitudinal member 3 and the hub element 6 and movements of the longitudinal member 3 are described hereinafter.

As shown in FIG. 2a, the connection element 7 includes a first coupling element 10 and a second coupling element 11. One end of the first coupling element 10 forms the first end 8 of the connection element 7 for fixedly coupling the longitudinal member 3 and the other end of the first coupling element 10 is coupled to one end of the second coupling element 11 to allow the movement of the longitudinal member 3 in the vertical plane, particularly about the second coupling element 11. Further, the other end of the second coupling element 11 forms the second end 9 of the connection element 7 for coupling to the hub element 6 to allow the movement of the longitudinal member 3 in the horizontal plane, particularly about the hub element 6.

In an implementation, the first coupling element 10 may be fixedly coupled at a cross-section of the longitudinal member 3. The fixed coupling may be such that there is insignificant relative movement between the first coupling element 10 and the longitudinal member 3. In case the longitudinal member 3 is hollow, the cross-section of the longitudinal member 3 is sealed to fix the first coupling element 10. The sealing on the cross-section of the longitudinal member 3 also prevents entering water in the longitudinal member 3.

In an implementation, the longitudinal member 3 may be provided with an intermediate coupling element 12, as shown in FIG. 2a, for fixedly coupling the first coupling element 10 of the connection element 7. In an implementation, the first coupling element 10 is bolted to the intermediate coupling element 12. Further, in an implementation, the intermediate coupling element 12 may be bolted, welded, cemented, fixed with an adhesive or fixed by any conventional means at the longitudinal member 3, such that there is an insignificant movement between the intermediate coupling element 12 and the longitudinal member 3.

In an implementation, the first coupling element 10 may be directly bolted, welded, cemented, fixed with an adhesive or fixed by any other conventional means at the longitudinal member 3.

Further, in an implementation, the coupling of the first coupling element 10 and the second coupling element 11 forms a first pivot joint which allows movement of the first coupling element 10 in the vertical plane about the second coupling element 11. For forming the first pivot joint, the first coupling element 10 includes a first extended element 13 and the second coupling element 11 includes an opening 14 to accommodate the first extended element 13, as shown in FIG. 2a. The first extended element 13 has a hole 15 configured along a horizontal axis 16. The second coupling element 11 has two holes 17 and 18 (holes 17 and 18 are more clearly shown in FIG. 2b), along a horizontal axis 19, which get aligned with the hole 15 when the first extended element 13 is accommodated in the opening 14. A fastening element, such as a pin 20, (shown in FIG. 2b) is passed through the holes 15, 17 and 18 of the first extended element 13 and the second coupling element 11, respectively, and secured, to couple the first coupling element 10 with the second coupling element 11. In the assembled state of the flexible joint 4 with the longitudinal member 3, at the first pivot joint, the first coupling element 10 and hence the longitudinal member 3 is movable in the vertical plane about the horizontal axis 19 passing through the holes 15, 17 and 18.

Further, in an implementation, the coupling of the second coupling element 11 and the hub element 6 forms a second pivot joint which allows movement of the second coupling element 11 in the horizontal plane about the hub element 6. For forming the second pivot joint, the second coupling element 11 includes a second extended element 21 with a hole 22 configured along a vertical axis 23. The second coupling element 11 is pivoted onto the hub element 6 through the hole 22 at the second extended element 21. In an assembled state of the flexible joint 4 with the longitudinal member 3, at the second pivot joint, the second coupling element 11 and hence the longitudinal member 3 is movable in the horizontal plane about the vertical axis 23 aligned with a longitudinal axis of the hub element 6.

Further, in an implementation, at each flexible joint 4, the coupling of the connection elements 7 at the hub element 6 is secured through a securing means, such as a nut 24, as shown in FIGS. 2a and 2b. The nut 24 may be secured on the hub element 6 after coupling the longitudinal members 3 at the hub element 6. The nut 24 prevents any uncoupling of one or more connection elements 7 from the hub element 6 during the aquatic farming.

In an implementation, the securing means also includes a spacer element 25 which is positioned on the hub element 6 before securing the nut 24. In an implementation, the spacer element 25 may be a sleeve or a washer of a predefined length based on the number of connection elements 7 coupled at the hub element 6. The spacer element 25 is configured to fill the space between the nut 24 and the top most connection element 7 at the hub element 6. The spacer element 25 facilitates in preventing any jumping movement or rattling of one or more connection elements 7 at the hub element 6 during the aquatic farming. In an implementation, the spacer element 25 may be made of a single piece or multiple pieces.

FIGS. 3a and 3b illustrate the flexible joint 4 of the farming structure 1, according to another embodiment of the present subject matter. FIG. 3a illustrates the flexible joint 4, in an unassembled or uncoupled state, for coupling an end of one longitudinal member 3, and FIG. 3b illustrates the flexible joint 4 coupling six longitudinal members 3. Similar to the embodiment shown in FIGS. 2a and 2b, the flexible joint 4 shown in FIGS. 3a and 3b includes a hub element 26 and a predefined number of connection elements 27 for coupling the longitudinal members 3. One longitudinal member 3 is coupled to the flexible joint 4 through one connection element 27. The number of connection elements 27 at the flexible joint 4 is dependent on the number of longitudinal members 3 to be coupled thereat. In an implementation, the number of connection elements 27 at one flexible joint 4 may be two to six.

The connection element 27, as shown in FIG. 3a, has a first end 28 configured to fixedly couple the end of the longitudinal member 3 and has a second end 29 configured to couple the same connection element 27 to the hub element 26. In an implementation, each connection element 27 coupled to the hub element 26 is configured to allow the respective longitudinal member 3 to move in all directions about the hub element 26.

In an implementation, the first end 28 of the connection element 27 is fixedly coupled at a cross-section of the longitudinal member 3 such that the is insignificant relative movement between the connection element 27 and the longitudinal member 3. As shown in FIG. 3a, the first end 28 of the connection element 27 may be of a flat cross-section and of a similar cross-sectional shape as that of the longitudinal member 3. In an implementation, the connection element 27 may be bolted, welded, cemented, fixed with an adhesive or fixed by any other conventional means at the longitudinal member 3.

In an implementation, as shown in FIG. 3a, at the second end 29 of the connection element 27 a ball element 31 is configured. For the sake of simplicity, the ball element 31 hereinafter is referred to as a ball 31. Further, in an implementation, as shown in FIGS. 3a and 3b, the hub element 26 has a plurality of sockets 32. The ball 31 of an individual connection element 27 coupled to the longitudinal member 3 couples with one of the sockets 32 to form a socket-ball joint. In an assembled state of the flexible joint 4 with the longitudinal member 3, at the socket-ball joint, the connection element 27 and hence the longitudinal member 3 is movable in all the directions about the hub element 26. With the socket-ball joint, the longitudinal member 3 is movable in a vertical plane about a horizontal axis 33 passing through the socket 32, in a horizontal plane about a vertical axis 34 passing through the socket 32 and also in 360° about a longitudinal axis 35 of the longitudinal member 3.

Further, in an implementation, at each flexible joint 4, the coupling of the connection elements 27 at the hub element 26 is secured through a securing means, such as a top cover 36 and a bottom cover 36′, as shown in FIG. 3a. The top cover 36 and the bottom cover 36′ may be secured on the hub element 26 after coupling the longitudinal members 3 at the hub element 26. The covers 36 and 36′ prevent any uncoupling of one or more connection elements 27 from the hub element 26 during the aquatic farming.

Although FIGS. 2b and 3b illustrate the flexible joint 4 coupling three and six longitudinal members 3, respectively; other numbers, two to six, of the longitudinal members 3 may be coupled on one flexible joint 4 in a similar manner. Furthermore, the each longitudinal member 3 at its each end is coupled to one of the flexible joints 4 in a manner shown in FIGS. 2a, 2b, 3a and 3b.

Configuring the farming structure 1 in the form of repeatable triangular structures 5 and with flexible joints 4, particularly according to the embodiments shown in FIGS. 2a, 2b, 3a and 3b, is flexible and stable that can sustain its intrinsic shape even under substantial stress from water waves without being damaged in the water-body 2. The flexibility of the farming structure 1 enables the farming structure 1 to shape itself to the wave profile of water in the water-body 2. This makes the farming structure 1 of the present subject matter substantially more durable. The farming structure 1 of the present subject matter is simple and easy to assemble, and can be assembled in situ.

For the purpose of aquatic farming in the water-body 2, the farming structure 1 of the present subject matter may be floatable on the surface of water or partially below the surface of water or at a predefined distance below the surface of water. In an implementation, the farming structure 1 may be intrinsically floatable or may be floatable through an external flotation means.

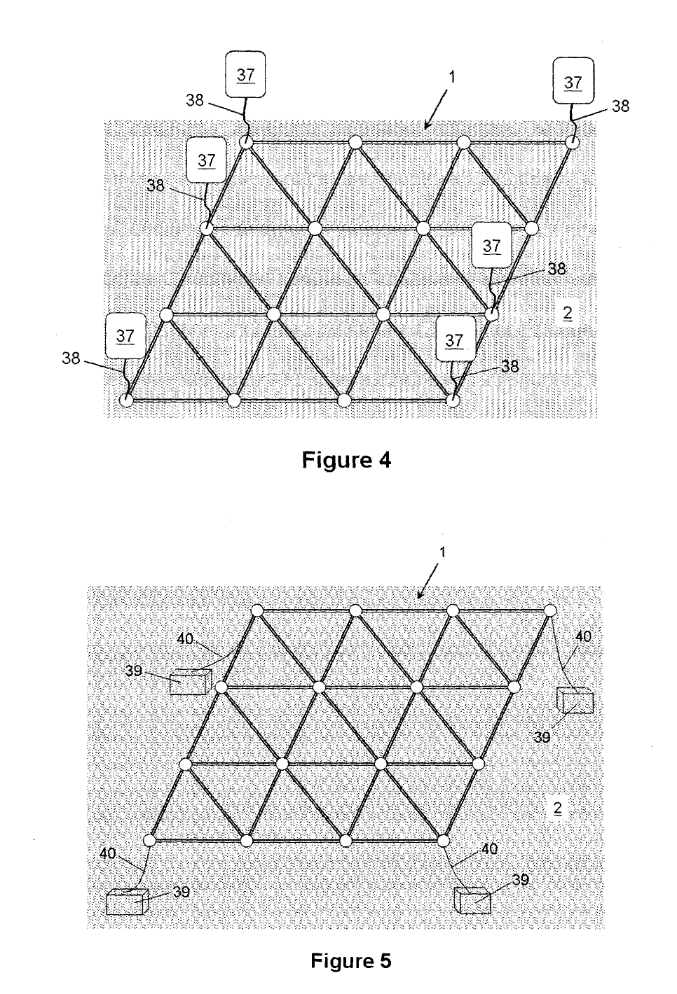

FIG. 4 illustrates the farming structure 1 with external flotation means, according to an embodiment of the present subject matter. The external flotation means may include one or more buoys 37 coupled to the farming structure 1. The buoys 37 may be coupled to the hub elements 6, 26 of the farming structure 1. In an implementation, the buoys 37 may be coupled to the farming structure 1 through flexible or rigid coupling means 38, such as ropes and rods.

In an implementation, the each buoy 37 may be of predefined buoyancy. The number and the positions of buoys 37 on the farming structure 1 are such that farming structure 1 floats at the predefined distance below the surface of water. It may be understood that the predefined buoyancy, the number and the position of the buoys 37 on the farming structure 1 depend on the weight and density of the farming structure 1. With the farming structure 1 floating at the predefine distance below the surface of water, for the purpose of aquatic farming the top of the farming structure 1 is accessible, for example, using a low-draft boat.

In an implementation, the farming structure 1 may be intrinsically floatable on or partially below the surface of water on the water-body 2. In an implementation, the longitudinal members 3 of the farming structure 1 may be floatable. For this, the each longitudinal member 3 may be hollow or solid and may include internal or external reinforcements that provide rigidity to the longitudinal member 3 and facilitate in making the longitudinal member 3 float. Examples of such internal or external reinforcements could be internal braces, longitudinal ribs, and poly urethane foam filling.

FIG. 5 illustrates the farming structure 1 anchored at a surface of the water-body 2, according to an embodiment of the present subject matter. The farming structure 1 may be anchored at the floor or base or any other surface of the water-body 2 to hold the farming structure 1 substantially at one place on or in the water-body 2. The anchoring of the farming structure 1 may be done through an anchoring means. In an implementation, the anchoring means may include a plurality of anchoring blocks 39 planted in the surface of the water-body 2 and coupled to the farming structure 1 through ropes or steel wires 40, as shown in FIG. 5.

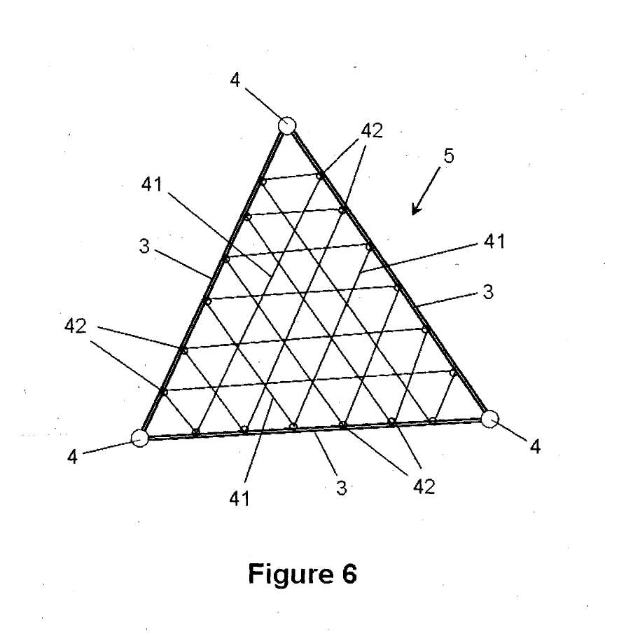

FIG. 6 illustrates one of the triangular structures 5 of the farming structure 1 with supporting means 41 for cultivation and growth of multicellular organisms thereon, according to an embodiment of the present subject matter. In an implementation, the supporting means 41 may include threads, ropes, nets or such other means that can support the multicellular organisms for their substantially dense growth. In an implementation, the longitudinal members 3 may be equipped with connecting means 42 for tying the supporting means 41 for the aquatic farming, as shown in FIG. 6. The connecting means 42 may include hooks, nails, quick fasteners, clips, and other similar means on which the supporting means 41 can be tied. Further, in an implementation, the supporting means 41 may be directly tied to the longitudinal member 3 without the use of any connecting means.

For the cultivation of multicellular organisms on the farming structure 1, the supporting means 41 are seeded with spores or vegetative propagules of a variety of seaweed. The seeded supporting means 41 are attached on the triangular structures 5 of the farming structure 1 and the seaweeds are allowed to grow in water for a predefined length of time based on the variety of seaweed. After this, the well grown seaweeds are harvested from the supporting means 41 of the farming structure 1 and the supporting means 41 are reseeded for next cycle of cultivation. In an implementation, the operation of seeding and harvesting of seaweeds on the farming structure 1 may be performed automatically or manually.

The farming structure 1 of the present subject matter is substantially flexible to maintain its overall 2-dimensional shape while the farming structure 1 is floating on or in the water-body 2 for aquatic farming. The farming structure 1 of the present subject matter is easy to assemble and disassemble, and offers substantial improvements in productivity of aquatic multicellular organisms.

Although embodiments for the farming structure 1 have been described in language specific to structural features, it is to be understood that the invention is not necessarily limited to the specific features described. Rather, the specific features are disclosed and explained in the context of a few embodiments for the farming structure 1.

Other advantages of the inventive farming structure 1 will become better understood from the description and claims of an exemplary embodiment of the farming structure 1. The inventive farming structure 1 of the present subject matter is not restricted to the embodiments that are mentioned above in the description.

Although the subject matter has been described with reference to specific embodiments, this description is not meant to be construed in a limiting sense. Various modifications of the disclosed embodiments, as well as alternate embodiments of the subject matter, will become apparent to persons skilled in the art upon reference to the description of the subject matter. It is therefore contemplated that such modifications can be made without departing from the spirit or scope of the present subject matter as defined.

1. A farming structure for aquatic farming, the farming structure comprising:
a plurality of longitudinal members; and
a plurality of flexible joints, one at each end of each of the plurality of longitudinal members coupling the plurality of longitudinal members to form repeating triangular structures adjacent to each other in a plane of the farming structure, wherein each end of each of the plurality of longitudinal members is independently movable in a horizontal plane and a vertical plane about a corresponding flexible joint.

2. The farming structure as claimed in claim 1, wherein at each end of each of the plurality of longitudinal members a first end of one connection element is fixedly coupled, and the each of the plurality of flexible joints comprises a hub element at which second ends of at least two connection elements are coupled.

3. The farming structure (1) as claimed in claim 2, wherein the connection element comprises:
a first coupling element; and
a second coupling element, wherein
one end of the first coupling element forms the first end of the connection element fixedly coupled to a respective longitudinal member;
other end of the first coupling element is coupled through a first pivot joint to one end of the second coupling element to allow movement of the respective longitudinal member in the vertical plane about the second coupling element; and
other end of the second coupling element forms the second end of the connection element coupled through a second pivot joint to a respective hub element to allow movement of the respective longitudinal member in the horizontal plane about the hub element.

4. The farming structure as claimed in claim 2, wherein the hub element comprises a plurality of sockets, and wherein the each connection element is a ball element forming a socket-ball joint with the hub element.

5. The farming structure as claimed in claim 2 further comprising a securing means for securing the coupling of the connection elements on the hub element.

6. The farming structure as claimed in claim 1, wherein each of the plurality of longitudinal members is floatable and is one of hollow and solid.

7. The farming structure as claimed in claim 6, wherein each of the plurality of longitudinal members has at least one of internal reinforcements and external reinforcements for providing rigidity to each of the plurality of longitudinal members and to make each of the plurality of longitudinal members float.

8. The farming structure as claimed in claim 6, wherein each of the plurality of longitudinal members is a rigid column.

9. The farming structure as claimed in claim 1, wherein each of the plurality of longitudinal members has a connecting means for tying supporting means for the aquatic farming.

10. The farming structure as claimed in claim 1, wherein each of the plurality of longitudinal members is made of at least one of plastic, metal and a composite material.

11. The farming structure as claimed in claim 1 further comprising an anchoring means coupled to the farming structure for anchoring the farming structure at a surface of a water body.

12. The farming structure as claimed in claim 2 further comprising at least one buoy of a predefined buoyancy coupled thereto, wherein the at least one buoy provides one of floatation of the farming structure at a water surface of a water body and floatation of the farming structure at a predefined distance below the water surface of the water body.

13. The farming structure as claimed in claim 12, wherein the at least one buoy is coupled to the hub element.

14. A flexible joint for coupling at least two longitudinal members of a farming structure for aquatic farming, wherein the flexible joint comprises:
a hub element; and
at least two connection elements coupled with the hub element,
wherein each of the at least two connection elements comprises:
a first coupling element; and
a second coupling element, wherein
one end of the first coupling element is fixedly couplable to one of the at least two longitudinal members;
other end of the first coupling element is pivoted at one end of the second coupling element such that the first coupling element is movable in a vertical plane about the second coupling element; and
other end of the second coupling element is pivoted at the hub element such that the second coupling element is movable in a horizontal plane about the hub element.

15. (canceled)

16. The flexible joint as claimed in claim 14 further comprising a securing means for securing the coupling of the connection elements on the hub element.

17. The flexible joint as claimed in claim 16, wherein the securing means comprises a spacer element and a nut secured on the hub element from one end thereof, wherein the spacer element is a sleeve of a predefined length based on a number of connection elements coupled to the hub element.

18. (canceled)

19. A flexible joint for coupling at least two longitudinal members of a farming structure for aquatic farming, wherein the flexible joint comprises:
a hub element having a plurality of sockets; and
at least two connection elements coupled with the hub element, wherein each of the at least two connection elements, at one end, is a ball element forming a socket-ball joint with one of the plurality of sockets of the hub element, and, at other end, is fixedly couplable to one of the at least two longitudinal members.

20. The flexible joint as claimed in claim 19, wherein the securing means comprises a top cover and a bottom cover secured on the hub element.

21. The flexible joint as claimed in claim 20 further comprising a securing means for securing the coupling of the connection elements on the hub element.
